(19) United States
(12) Patent Application Publication
(10) Pub. No.: US 2007/0146550 A1
(43) Pub. Date: Jun. 28, 2007

(54) RECEIVING CIRCUIT, RECEIVING APPARATUS, AND RECEIVING METHOD

(75) Inventors: Makoto IKUMA, Osaka (JP); Yasuo OBA, Osaka (JP); Sachiko MORI, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/614,292

(22) Filed: Dec. 21, 2006

(30) Foreign Application Priority Data
Dec. 27, 2005 (JP) 2005-376599

(51) Int. Cl. H04N 5/455

(52) U.S. Cl. 348/726

(57) ABSTRACT

Provided is a receiving circuit which determines whether a PLL circuit is at a locked state or a unlocked state, and thereby realizing an AFT system that operates correctly. The receiving circuit is a video/audio signal processing circuit which demodulates the first signal and the second signal included in a signal received from a tuner circuit. The video/audio signal processing circuit includes: a PLL circuit which generates a synchronizing signal synchronized with a phase of the received signal; a video demodulator which demodulates a signal including the first signal from the received signal, using the generated synchronizing signal; a second demodulator which demodulates the second signal from the received signal; and a lock detection circuit which determines whether the PLL circuit is at a locked state or an unlocked state by judging whether or not a frequency of the demodulated second signal is a predetermined value, and then outputs a lock detection signal representing the determination result to the PLL circuit. The PLL circuit changes a response speed of the phase synchronization based on the lock detection signal.

### BACKGROUND OF THE INVENTION

(1) Field of the Invention

The present invention relates to a receiving circuit for receiving television signals and the like, and more particularly to a receiving circuit suitable in a receiving apparatus having an Automatic Fine Tuning (AFT) control circuit for supplying signals to control an oscillation frequency of a local oscillator.

(2) Description of the Related Art

In television receivers, an AFT system is used to select channels properly and demodulate video signals with good image quality and audio signals with good sound quality.

The first function of the AFT system is automatically tuning a frequency of a video intermediate frequency signal to be a regulated frequency, by supplying a signal whose frequency corresponds to a frequency difference between the video intermediate frequency signal outputted from a tuner circuit and the regulated video intermediate frequency signal, from an AFT control circuit to a local oscillator at a prior state. For example, recently, in cable television services (CATV) or the like, in which broadcast channel signals are converted to be re-transmitted using cables, a video intermediate frequency signal is deviated from the regulated frequency. In such a case, this AFT system has advantages. Using the AFT system, the video intermediate frequency is automatically tuned to be regulated 58.75 MHz in Japan, or regulated 45.75 MHz in the United States of America, so that the best reception video and audio can be obtained.

The second function of the AFT system is automatically selecting receivable channels. A micro-computer automatically selects receivable channels, using S-characteristics which is provided from the AFT control circuit to control the local oscillator, and a synchronizing signal of a video demodulation signal outputted from a synchronizing signal separator circuit. That is, assuming a frequency of a selected channel is f0, determination is made as to whether or not the channel is able to be received, according to a level of an AFT output signal having a frequency f0±Δf and existence of the synchronizing signal. Then, if the micro-computer determines that the channel is able to be received, then the receivable frequency and the receivable channel number are stored in a memory.

Various receiving apparatuses having a tuner circuit 11 and a video audio circuit 100 for realizing the above AFT system, such as conventional tuner packs, are disclosed in patent reference 1 (Japanese Patent Application Laid-Open No. 10-32767), a patent reference 2 (Japanese Patent Application Laid-Open No. 10-32768), and the like, for example. One typical example of those receiving apparatuses is described below with reference to FIG. 1. FIG. 1 is a circuit diagram showing a configuration of the receiving apparatus using a split carrier method by which television waves are separated, prior to intermediate frequency amplification, to video signals and audio signals to be processed.

This receiving apparatus mainly includes a tuner circuit 11 and a video/audio signal processing circuit 100. The tuner circuit 11 selects a frequency of a desired channel from high-frequency television signals received by an antenna 10, and converts the selected frequency to a video intermediate frequency. The video/audio signal processing circuit 100 demodulates the video intermediate frequency to be a video signal. The video/audio signal processing circuit 100 has a Video Intermediate Frequency (VIF) amplifier 20, a video demodulator 21, a video amplifier 22, a Phase Locked Loop (PLL) circuit 27, an Automatic Gain Control (AGC) circuit 28, an AFT control circuit 30, an unlock detection circuit 34, and an audio signal processing circuit. The audio signal processing circuit includes an audio intermediate frequency (QIF) amplifier 50, an audio mixer circuit 51, a Band-Pass Filter (BPF) 52, a limiter circuit 53, and a Frequency Modulation (FM) demodulator 54.

A frequency of a desired channel is selected by the tuner circuit 11 from high-frequency television signals in an Ultra High Frequency (UHF) zone or a Very High Frequency (VHF) zone, which are received by the antenna 10, and the selected frequency is amplified. For example, a video signal is converted to a video intermediate frequency signal of a regulated frequency 58.75 MHz in Japan, or a regulated frequency 45.75 MHz in the United States of America.

Next, through a video Surface Acoustic Wave (SAW) filter 12 having characteristics of a band-pass light filter for the video intermediate frequency signal, only the video intermediate frequency signal is selected, passed, and provided to the video/audio signal processing circuit 100. This video intermediate frequency signal is amplified by the VIF amplifier 20 and provided to the video demodulator 21. The output signal (signal b) of the VIF amplifier 20 is provided also to the PLL circuit 27 which has a phase detector 23, a Low-Pass Filter (LPF) 25, a Voltage-Controlled Oscillator (VCO) 26, and a phase shifter 24.

The PLL circuit 27 is a circuit for generating a synchronizing signal which is in synchronization with a phase of the received signal (video intermediate frequency signal). In this PLL circuit 27, a phase of an output (signal s) of the VCO 26 is shifted by the shifter 24 in order to generate a signal a which is then provided to the phase detector 23. Furthermore, an output signal (signal b) of the VIF amplifier 20 is also provided to the phase detector 23. The phase detector 23 detects a frequency difference (phase difference) between the two signals a and b. An output of the phase detector 23 is smoothed by the LPF 25 in order to generate an oscillation frequency control voltage (signal d) which is then fed back to the VCO 26. As a result, an oscillation frequency of the VCO 26 becomes the same as the received video intermediate frequency (58.75 MHz in Japan, for example), the phase difference between the signals a and b becomes 90 degrees, and the PLL circuit 27 operates as a phase locked loop.

On the other hand, the signal c, whose phase is shifted with 90 degrees from the signal a by the phase shifter 24, is provided to the video demodulator 21. As a result, a phase of the output signal of the VIF amplifier 20 becomes the same as a phase of the output signal c of the phase shifter 24, and the video demodulator 21 performs synchronous demodulation of a video signal. The demodulated signal is amplified by the video amplifier 22, and outputted as a video signal from a video signal output terminal 29.

The AGC circuit 28 judges a level of the video intermediate frequency signal outputted from the tuner circuit 11, according to the amplitude of the video signal outputted from the video demodulator 21. If the level of the video intermediate frequency signal is low, then a gain of the VIF amplifier 20 is controlled to be higher. On the other hand, if the level of the video intermediate frequency signal is high, then the gain of the VIF amplifier 20 is controlled to be lower. Thereby the AGC circuit 28 controls the level of the video signal outputted from the video demodulator 21 to be always constant.

Next, processing of audio signals is described below. An audio intermediate frequency signal having a frequency 54.25 MHz is outputted together with the video intermediate frequency signal having a frequency 58.75 MHz from the mixer circuit 61 in the tuner circuit 11 shown in FIG. 2. Then, the audio intermediate frequency signal is passed through an audio SAW filter 13 having band-pass characteristics of 54.25 MHz, and amplified by the QIF amplifier 50. Next, this signal is mixed by the audio mixer circuit 51 with the signal of 58.75 MHz which is provided via the phase shifter 24 to the VCO 26, thereby being applied with frequency conversion to be the second audio intermediate frequency signal of a frequency 4.5 MHz. This second audio intermediate frequency signal is provided to the BPF 52 through which only the second audio intermediate frequency signal of 4.5 MHz is passed. Then, the second audio intermediate frequency signal is amplified by the limiter circuit 53, and applied with FM demodulation by the FM demodulator 54 having an oscillation frequency of 4.5 MHz, so that an audio signal is eventually outputted from the audio signal output terminal 55.

Next, the AFT control circuit is described below.

Using the oscillation frequency control voltage (signal d) corresponding to the oscillation frequency of the VCO 26 which is locked at the received video intermediate frequency, the analog AFT control circuit generates an AFT control signal whose frequency corresponds to a frequency difference between the received video intermediate frequency signal and a regulated video intermediate frequency signal. Since this signal processing is analog, the processing is easily affected by source voltages, an ambient temperature, and also variations of the circuit elements such as transistors, capacitors, and resistors. In general, the circuit configuration becomes complicated due to controlling of resolution of a necessary frequency to be about 10 kHz, and a cost is increased due to fine adjustment in a final inspection process for integrated circuits (IC).

On the other hand, the digital AFT control circuit digitally counts the oscillation frequency of the VCO 26 which is locked to the received video intermediate frequency signal. Therefore, the signal processing is not affected by the source voltages, the IC ambient temperature, nor the variations of circuit elements, so that it is relatively easy to control resolution of a necessary frequency to be about 10 kHzh although the easiness depends on a size of the circuit. The AFT control signal whose frequency corresponds to the frequency difference between the received video intermediate frequency signal and the regulation video intermediate frequency signal is outputted as a digital signal, or converted to be an analog signal by a digital/analog (D/A) conversion circuit to be outputted as an analog signal.

In the digital AFT control circuit, the output signal of the VCO 26 in synchronization with the received video intermediate frequency signal is firstly connected to an input of the AFT control circuit 30. Then a frequency counter in the AFT control circuit 30 counts frequency of the video intermediate frequency signal. Note that the frequency counting is performed using an exact reference frequency, generally an oscillation frequency of a crystal oscillator (XtalOSC) 14. The oscillation frequency is, for example, 3.58 MHz or 4.00 MHz, having relatively high frequency accuracy, such as several kHz.

Output characteristics of the AFT control circuit 30 is S-characteristics shown in FIG. 3. FIG. 3 shows a relationship (S-characteristics) between a video intermediate frequency (MHz) of a signal inputted to the AFT control circuit 30 and an output signal (ATF output voltage) of the AFT control circuit 30. When the output signal 42 of the unlock detection circuit 34 indicates that the PLL circuit 27 is at a locked state, the AFT control circuit 30 outputs, as the output signal (AFT output voltage) 40, a voltage (voltage varying from a Vcc level to a ground level) corresponding to a frequency difference between a regulated video intermediate frequency and the received video intermediate frequency. On the other hand, in a high-frequency region and a low-frequency region quite far from the regulated video intermediate frequency, in other words, if the output signal 42 of the unlock detection circuit 34 indicates that the PLL circuit 27 is at an unlocked state, the AFT control circuit 30 outputs a center voltage as the output signal (AFT output voltage) 40.

This output signal 40 of the AFT control circuit 30 having the S-characteristics is fed back to the local oscillator 62 in the tuner circuit 11 (as shown in FIG. 2). As a result, even if the received frequency varies, or even if a frequency of the local oscillator 62 varies depending on an ambient temperature or time, the video intermediate frequency is automatically adjusted, for example, to be always a regulated frequency 58.75 MHz in Japan. Further, in the automatic channel selecting, the micro-computer 15 selects receivable channels, using a signal having this S-characteristics and a synchronizing signal of the video demodulation signal outputted from the synchronizing signal separator circuit 18.

In the meantime, as disclosed in the above-mentioned patent references 1 and 2, and another patent reference 3 (Japanese Patent publication No. 2710990) and the like, for example, the unlock detection circuit 34, which determines whether a state of the conventional PLL circuit 27 is a locked state or an unlocked state, has a circuit configuration shown in FIG. 4 or FIG. 5. As shown in FIG. 4 or FIG. 5, the unlock detection circuit 34 includes a comparator b 90 (or a comparator c 93) and the like which compares an output signal (video signal) 44 of the video demodulator 21 to a predetermined reference voltage Vref2 (or Vref3) shown in FIGS. 6A to 6C. Using the comparator and the like, the unlock detection circuit 34 can determine whether the state of the conventional PLL circuit 27 is a locked state or an unlocked state, and outputs an output signal 42 indicating a result of the determination.

However, the conventional unlock detection circuit 34 has the following problems (1) to (3).

(1) Firstly, there is a problem that, during over-modulation where the modulation ratio of the video signal exceeds 100%, the conventional unlock detection circuit 34 determines wrongly that the state of the PLL circuit 27 is an unlocked state, although the state is actually a locked state.

The unlock detection circuit 34, which is disclosed in the patent references 1 and 2, detects an unlocked state, using the comparator b 90 which compares the output signal 44 of the video demodulator 21 to the predetermined reference voltage Vref2, as shown in FIG. 4. At a locked state, the video signal 44 does not exceed the reference voltage Vref2, as shown, for example, as a video signal waveform of FIG. 6B, so that the state of the PLL circuit 27 is correctly determined by the unlock detection circuit 34 as the locked state. On the other hand, at an unlocked state, the video demodulator 21 outputs a beat signal having a frequency difference between the oscillation frequency of the VCO 26 and the received video intermediate frequency, as shown, for example, as a video signal waveform of FIG. 6A. Here, the video signal 44 exceeds the reference voltage Vref2, so that the state of the PLL circuit 27 is correctly determined by the unlock detection circuit 34 as the unlocked state.

However, during over-modulation where the modulation ratio of the video signal exceeds 100%, the video signal 44 exceeds the reference voltage Vref2 as shown, for example, as a video signal waveform of FIG. 6C. Therefore, the state of the PLL circuit 27 is wrongly determined as an unlocked state by the unlock detection circuit 34, although the state is actually a locked state.

Furthermore, the unlock detection circuit 34 disclosed in the patent reference 3 detects an unlocked state of the PLL circuit 27, using the comparator c 93 which compares (i) an output signal which is outputted from the video demodulator 21 and smoothed by the smoothing circuit 92 to (ii) the predetermined reference voltage Vref3. At a locked state, a signal Vp obtained by smoothing the video signal 44 does not exceed the reference voltage Vref3 as shown, for example, as the video signal waveform of FIG. 6B, so that the state of the PLL circuit 27 is correctly determined by the unlock detection circuit 34 as the locked state. On the other hand, at an unlocked state, the video demodulator 21 outputs a beat signal having a frequency difference between the oscillation frequency of the VCO 26 and the received video intermediate frequency as shown, for example, as the video signal waveform of FIG. 6A. Here, the signal Vp obtained by smoothing the video signal 44 exceeds the reference voltage Vref3, so that the state of the PLL circuit 27 is correctly determined by the unlock detection circuit 34 as the unlocked state.

However, during over-modulation where the modulation ratio of the video signal exceeds 100%, the video signal 44 exceeds the reference voltage Vref2 as shown, for example, as the video signal waveform of FIG. 6C. Therefore, the state of the PLL circuit 27 is wrongly determined by the unlock detection circuit 34 as an unlocked state, although the state is actually a locked state.

Particularly in recent years, broadcasting has sometimes been provided in a condition where video signals transmitted from a broadcast station are excessively amplified, thereby resulting in an over-modulation condition of the modulation ratio exceeding 100%. In the over-modulation condition where the modulation ratio of the video signal is high, the conventional unlock detection circuit 34 determines wrongly that the state of the PLL circuit 27 is an unlocked state, although the state is actually a locked state. As a result, the AFT control circuit 30 performs false operations, which makes it difficult to select channels correctly.

(2) Secondly, there is another problem that, in an area where a ratio (PS ratio) of a transmitted audio level to a transmitted video level is high, the state of the PLL circuit 27 is wrongly determined by the conventional unlock detection circuit 34 as is an unlocked state, although the state is actually a locked state.

Video signal waveforms of monochrome signals (luminance signals) at the locked state and the unlocked state are shown in FIGS. 6A to 6C. However, the monochrome signal is usually overlapped with a chrominance signal (chroma signal) and an audio signal. Particularly in an inter carrier method for separating television waves to video signals and audio signals after intermediate frequency amplification, a level of the audio signal overlapped with the video waveform is higher than the case using the split carrier method. Furthermore, the ratio (PS ratio) of an audio level to a video level in a transmitting side greatly varies about from 0 dB to −20 dB depending on areas. Therefore, particularly in an area with a high PS ratio, the ratio of the audio signal overlapped with the video signal 44 is increased, so that there is a possibility that the video signal exceeds the reference voltage Vref2 or Vref3. As a result, the state of the PLL circuit 27 is wrongly determined by the conventional unlock detection circuit 34 as an unlocked state, although the state is actually a locked state.

(3) Thirdly, there is still another problem that the conventional unlock detection circuit 34 disclosed in the patent references 1 and 2 has a complicated circuit configuration for analog signal processing, so that, for example, so that the video signal 44 and the reference voltages Vref2 and Vref3 are quite easily affected by source voltages, an ambient temperature, and also variations of circuit elements such as transistors, capacitors, and resistors. As a result, there is a high possibility of wrongly determining the state of the PLL circuit 27.

### SUMMARY OF THE INVENTION

Thus, in order to solve the above problems, an object of the present invention is to provide a receiving circuit and the like which correctly determine whether or not the PLL circuit is at a locked state or an unlocked state, thereby realizing an AFT system which operates correctly.

In order to achieve the above object, the receiving circuit according to the present invention demodulates a first signal and a second signal included in a signal received from a tuner circuit. The receiving circuit includes: a phase lock circuit which generates a synchronizing signal synchronized with a phase of the received signal; a first demodulator which demodulates a signal including the first signal from the received signal, using the generated synchronizing signal; a second demodulator which demodulates the second signal from the received signal; and a phase lock detector which determines whether the phase lock circuit is at a locked state or an unlocked state by judging whether or not a frequency of the demodulated second signal is a predetermined value, and then outputs a lock detection signal representing the determination result to the phase lock circuit, wherein the phase lock circuit changes a response speed of the phase synchronization based on the lock detection signal. Thereby, the determination of the locked/unlocked state of the PLL circuit is made based on the second signal separated from the received signal, so that the determination is different from the conventional determination which is made based on the first signal for which synchronous demodulation is to be performed, which makes it possible to prevent that a locked state is wrongly determined as an unlocked state, during over-modulation and in an area of a high receiving level. As a result, the locked/unlocked state of the PLL circuit is correctly determined, which realizes the AFT system operating correctly.

Here, the receiving circuit may further include an electric field level detection circuit which detects electric field level of the received signal and outputs an electric field level detection signal representing the detection result to the phase lock circuit, wherein the phase lock circuit changes the response speed of the phase synchronization based on the electric field level detection signal.

Thereby, for example by slowing down a response to phase synchronization when electric field level is high, a response to noise or phase distortion becomes difficult, it is possible to stabilize the PLL operation.

Further, the receiving circuit may further include: a first signal amplifier which selectively performs one of amplification and mutiny for the demodulated first signal; and a mute circuit which makes the first signal amplifier selectively perform one of the amplification and the muting, based on the lock detection signal outputted from the phase lock detector. Thereby, the first signal is amplified or muted depending on the locked/unlocked state, so that, when this signal is inputted to a micro-computer via a synchronizing signal separator circuit, the micro-computer can correctly determine the presence of the synchronizing signal, which makes it possible to correctly select receivable channels.

Furthermore, it is preferable that the receiving circuit further includes an automatic fine tuning circuit which controls the tuner circuit to select a channel, based on the synchronizing signal generated by the phase lock circuit, wherein the automatic fine tuning circuit outputs a voltage corresponding to the synchronizing signal when the lock detection signal represents a locked state as the determination result, and outputs a regulated fixed voltage when the lock detection signal represents an unlocked state as the determination result, and that the receiving circuit further includes: an automatic fine tuning circuit which controls the tuner circuit to select a channel, based on the synchronizing signal generated by the phase lock circuit; and an electric field level detection circuit which detects electric field level of the received signal and outputs an electric field level detection signal representing the detection result to the automatic fine tuning circuit, wherein the automatic fine tuning circuit outputs a voltage corresponding to the synchronizing signal when the electric field level detecting signal represents a medium or high electric field as the detection result, and outputs a regulated fixed voltage when the electric field level detecting signal represents a low electric field as the detection result. Thereby, the AFT control circuit operates according to the locked/unlocked state of the PLL circuit and the electric field level, thereby realizing an AFT system operating correctly.

Moreover, the present invention can be realized as a receiving apparatus in which the second demodulator includes a mixer circuit which demodulates the second signal from the received signal, by mixing the synchronizing signal generated by the phase lock circuit and the received signal, and the phase lock detector determines whether the phase lock circuit is at a locked state or an unlocked state, by detecting a frequency of the second signal outputted from the mixer circuit is the predetermined value, and as a receiving apparatus in which the second demodulator includes a band-pass filter which extracts the second signal from the signal including the first signal demodulated by the first demodulator, and the phase lock detector determines whether the phase lock circuit is at a locked state or an unlocked state, by detecting a frequency of the second signal outputted from the band-pass filter is the predetermined value.

Further, it is preferable that the phase lock detector includes: a frequency divider which performs variable frequency dividing for a reference frequency provided from a reference signal source, depending on a reference frequency switching signal; a counter which counts a frequency of the second signal, during a period decided by a cycle represented by a signal outputted from the frequency divider; and a comparator which judges whether or not the frequency counted by the counter is a predetermined value. Thereby, a frequency of the second signal is measured by digital processing, so that the determination of the locked/unlocked state of the PLL circuit is stabilized, without depending on source voltages, an ambient temperature, also variations of circuit elements such as transistors, and the like.

Furthermore, it is preferable that the phase lock detector further includes a hold circuit which holds a series of the judgment results of the comparator per a predetermined number of the results, and outputs the lock detection signal which represents whether or not the determination results held per the predetermined number are the same results. Thereby, the variations in the determination are smoothed, the instability of the phase lock detector or in the switching state between the locked state and unlocked state of the PLL circuit can be significantly reduced.

Still further, the first signal may be a video signal, and the second signal may be an audio signal corresponding to the video signal. Still further, the first signal may be a luminance signal, and the second signal may be a chrominance signal corresponding to the luminance signal.

Moreover, the present invention can be realized as not only the above-described receiving circuit, but also: a receiving apparatus which demodulates a first signal and a second signal included in a signal received by an antenna, including: a tuner circuit which retrieves a signal of a selected channel from the received signal; and the receiving circuit according to claim 1 which demodulates the first signal and the second signal included in the signal retrieved by the tuner circuit; a receiving method of demodulating a first signal and a second signal included in a signal received from a tuner circuit; and a method of determining the locked/unlocked state of the PLL circuit.

According to the present invention, even during the video signal over-modulation or even in an area of a high PS ratio, it is possible to prevent the problem that the locked/unlocked state of the PLL circuit is wrongly determined. Furthermore, the determination of the locked/unlocked state of the PLL circuit is stabilized, without being affected by source voltages, an ambient temperature, also variations of circuit elements such as transistors, and the like.

Thus, according to the present invention, the locked/unlocked state of the PLL circuit is correctly determined, which makes it possible to stabilize the PLL operation and to realize an AFT system operating correctly, so that the present invention is highly suitable for practical use.

### FURTHER INFORMATION ABOUT TECHNICAL BACKGROUND TO THIS APPLICATION

The disclosure of Japanese Patent Application No. 2005-376599 filed on Dec. 27, 2005 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate specific embodiments of the present invention. In the Drawings:

FIG. 1 is a block diagram showing a configuration of the conventional receiving apparatus;

FIG. 2 is a detailed circuit diagram of a tuner circuit;

FIG. 3 is a graph showing characteristics of an AFT control circuit (video intermediate frequency versus AFT output voltage);

FIG. 4 is a detailed circuit diagram of the conventional unlock detection circuit;

FIGS. 5 is a detailed circuit diagram of another conventional unlock detection circuit;

FIG. 6A is a graph showing a video signal waveform at a locked state;

FIG. 6B is a graph showing a video signal waveform at an unlocked state;

FIG. 6C is a graph showing another video signal waveform at an unlocked state;

FIG. 7 is a block diagram showing a configuration of a receiving apparatus according to the first embodiment of the present invention;

FIG. 8 is a detailed circuit diagram of an electric field level detection circuit;

FIG. 9 is a detailed circuit diagram of the AFT control circuit;

FIG. 10 is a time chart showing timings of signals in the AFT control circuit;

FIG. 11 is a graph showing a relationship, at a locked state, among a frequency fVIF of a video intermediate frequency signal, a frequency fQIF of an audio intermediate frequency signal, and an oscillation frequency fVCO of a voltage-controlled oscillator;

FIG. 12 is a graph showing a relationship, at an unlocked state, among a frequency fVIF of a video intermediate frequency signal, a frequency fQIF of an audio intermediate frequency signal, and an oscillation frequency fVCO of a voltage-controlled oscillator;

FIG. 13 is a detailed circuit diagram of a lock detection circuit;

FIG. 14 is a detailed circuit diagram of a hold circuit;

FIG. 15 is a time chart showing timings of signals in the lock detection circuit;

FIG. 16 is a graph showing characteristics of an AGC circuit;

FIG. 17 is a graph showing characteristics of the AFT control circuit (video intermediate frequency signal level versus AFT output voltage); and

FIG. 18 is a block diagram showing a configuration of a receiving apparatus according to the second embodiment of the present invention.

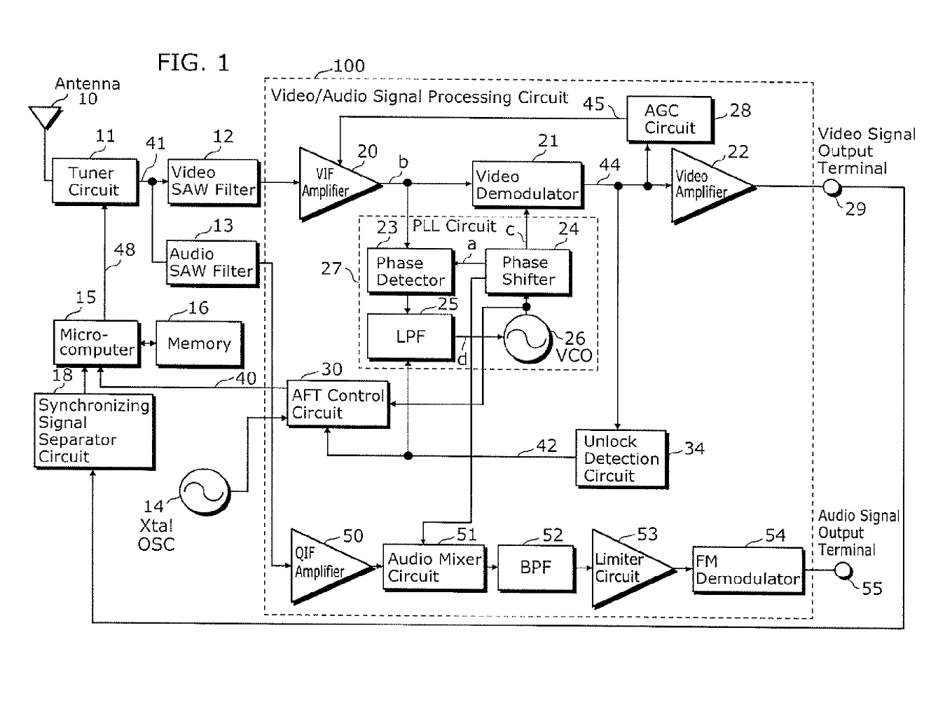

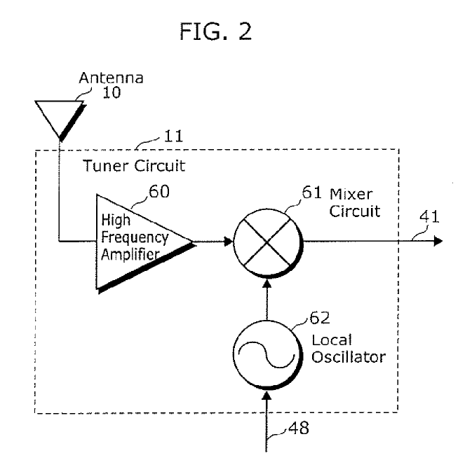

### DESCRIPTION OF THE PREFERRED EMBODIMENT(S)

The following describes the embodiments according to the prevent invention with reference to the drawings.

### First Embodiment

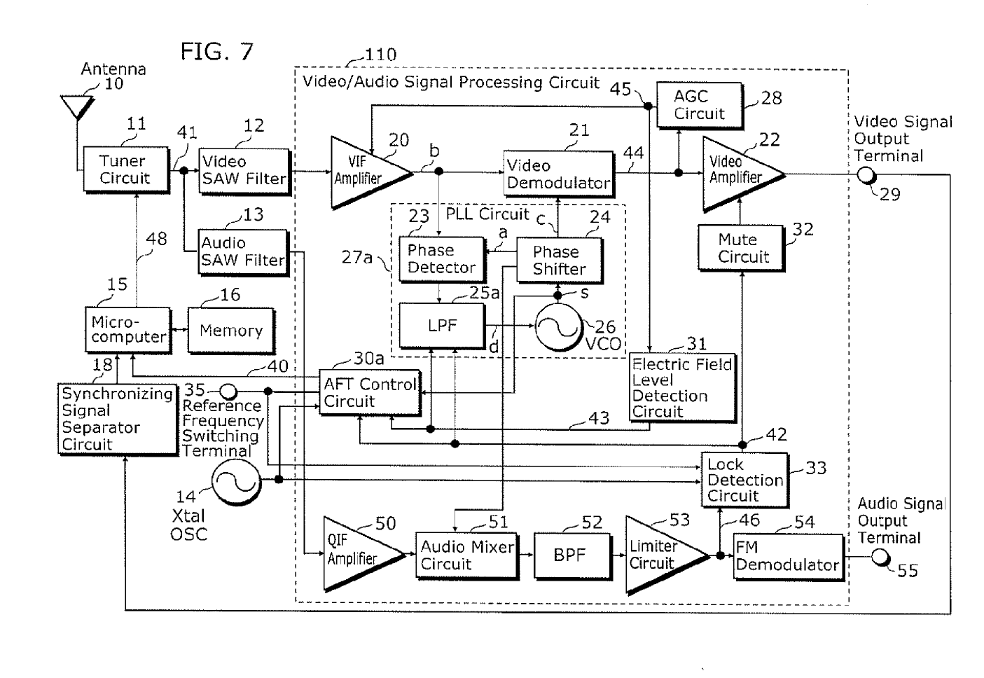

FIG. 7 is a block diagram showing a configuration of a receiving apparatus according to the first embodiment of the present invention. This receiving apparatus receives television signals using a split carrier method characterized in detection of a locked/unlocked state of a PLL circuit based on the second audio intermediate frequency signal. This receiving apparatus has an antenna 10, a tuner circuit 11, a video SAW filter 12, an audio SAW filter 13, an OSC 14, a micro-computer 15, a memory 16, a synchronizing signal separator circuit 18, and a video/audio signal processing circuit 110.

The video/audio signal processing circuit 110 is one example of a receiving circuit which demodulates, from a signal transmitted from the tune circuit, the first signal and the second signal included in the received signal. In addition to elements having the same functions as the conventional functions (the VIF amplifier 20, the video demodulator 21, the video amplifier 22, the AGC circuit 28, the QIF amplifier 50, the audio mixer circuit 51, the BPF 52, the limiter circuit 53, and the FM demodulator 54), the video/audio signal processing circuit 110 further has elements characterized in the present invention, which are an electric field level detection circuit 31, a lock detection circuit 33, a mute circuit 32, an AFT control circuit 30a, and a PLL circuit 27a. The electric field level detection circuit 31 determines whether a level of a video intermediate frequency signal outputted from the tuner circuit 11 is low or medium/high. The lock detection circuit 33 determines whether the state of the PLL circuit 27a is a locked state or a unlocked state. The mute circuit 32 mutes a video signal 44 at an unlocked state. The AFT control circuit 30a receives, as input, a signal from the electric field level detection circuit 31 as well as signals from the OSC 14, the VCO 26, and the lock detection circuit 33, and outputs an AFT output voltage 40. The PLL circuit 27a has a LPF 25a which operates in response to not only an output signal 42 of the lock detection circuit 33, but also an output signal 43 of the electric field level detection circuit 31.

Note that the video demodulator 21 is one example of the first demodulator, and the audio mixer circuit 51 is one example of the second demodulator in the claims appended with this specification. In the following, the same elements are designated by the same reference numerals, and explanation for the elements is not repeated.

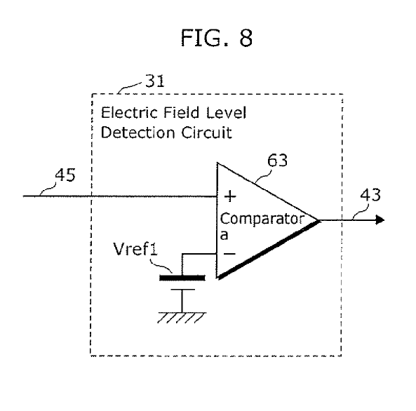

As shown in a detailed circuit diagram of FIG. 8, the electric field level detection circuit 31 has a comparator a 63. This comparator a 63 compares (i) an output signal 45 of the AGC circuit 28 which varies depending on the electric field level of the video intermediate frequency signal outputted from the tuner circuit 11 to (ii) a predetermined threshold voltage Vref1. Using the comparator a 63, it is judged whether the electric field level of the video intermediate frequency signal is low or medium/high, and then the resulting judgment signal (electric field level detection signal) is outputted to the LPF 25a and the AFT control circuit 30a.

The lock detection circuit 33 is a circuit which determines whether the state of the PLL circuit 27a is a locked state or a unlocked state, by judging whether or not a frequency of the second audio intermediate frequency signal is equal to a predetermined value, and then the resulting determination signal (lock detection signal) is outputted to the LPF 25a, the AFT control circuit 30a, and the mute circuit 32.

The following describes processing performed by the receiving apparatus having the above-described configuration, and a method of determining the locked/unlocked state of the PLL circuit 27a.

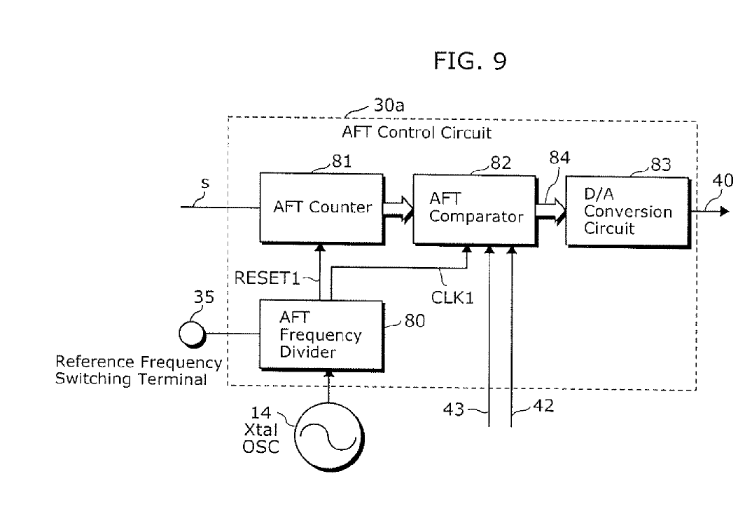

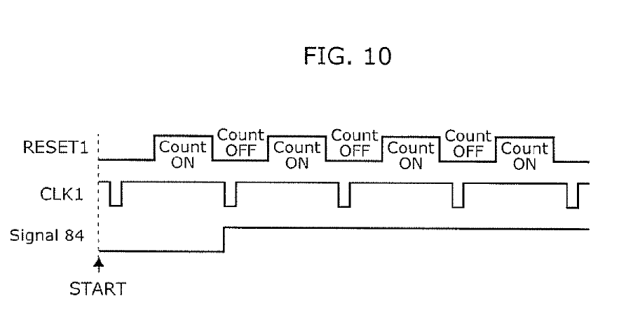

Firstly, the AFT control circuit 30a is described. The AFT control circuit 30a has a function of counting an oscillation frequency of the VCO 26. FIG. 9 is a detailed circuit diagram of the AFT control circuit 30a. The AFT control circuit 30a has an AFT frequency divider 80, an AFT counter 81, an AFT comparator 82, and a D/A conversion circuit 83. FIG. 10 is a time chart showing timings of respective signals (RESET 1, CLK 1, and signal 84) at main points shown in FIG. 10. The output signal 40 of the AFT control circuit 30a is provided via the micro-computer 15 to the local oscillator 62 in the tuner circuit 11.

Firstly, a reference frequency switching signal corresponding to an oscillation frequency of the XtalOSC 14 is provided from the reference frequency switching terminal 35 to the AFT frequency divider 80. Based on this reference frequency switching signal, the AFT frequency divider 80 performs variable frequency dividing for the reference signal from the XtalOSC 14. More specifically, the AFT frequency divider 80 switches a division ratio to equalize cycles of the output signal RESET 1, and then outputs the signal RESET 1. The AFT counter 81 counts a frequency of a signal s supplied from the VCO 26, by counting the signal s during a period decided depending on the cycles of the output signal RESET 1 of the AFT frequency divider 80.

The AFT comparator 82 connected to an output terminal of the AFT counter 81 receives the output signal 42 of the lock detection circuit 33 and the output signal 43 of the electric field level detection circuit 31. If the output signal 43 of the electric field level detection circuit 31 represents that the electric field level of the video intermediate frequency signal is medium or high and the output signal 42 of the lock detection circuit 33 represents that the PLL circuit 27a is at a locked state, then the AFT comparator 82 outputs a signal 84 corresponding to difference between a regulated video intermediate frequency and the oscillation frequency of the VCO 26. On the other hand, if the output signal 43 of the electric field level detection circuit 31 represents that the electric field level is low and the output signal 42 of the lock detection circuit 33 represents that the PLL circuit 27a is at an unlocked state, then the AFT comparator 82 outputs a signal 84 which is predetermined as a fixed value. Every time the signal CLK 1 is supplied from the AFT frequency divider 80, the AFT comparator 82 outputs a signal 84 representing the above-mentioned difference or fixed value, to the D/A conversion circuit 83. The D/A conversion circuit 83 outputs an analog voltage corresponding to the value, as an output signal (AFT output voltage) 40.

Note that the oscillation frequency of the XtalOSC 14 is set by a set maker or a tuner pack maker, to be 3.58 MHz or 4.00 MHz, for example, as the situation demands. For example, depending on signals from the reference frequency switching terminal 35 corresponding to these reference frequencies, division ratios of the AFT frequency divider 80 are set to 179 and 200, respectively. Thereby, the signal RESET 1 has a frequency of 20 kHz having equal cycles, so that the same AFT counter 81 can deal with different reference frequencies, which therefore simplifies the circuit.

Next, the lock detection method performed by the receiving apparatus according to the first embodiment is briefly described. At a locked state where the PLL circuit 27a locks a video intermediate frequency fVIF, a frequency difference between the oscillation frequency fVCO of the VCO 26 and a sound intermediate frequency fQIF is constantly maintained to be a frequency fSIF of the regulated second audio intermediate frequency signal. On the other hand, at an unlocked state where the PLL circuit 27a does not lock the video intermediate frequency fVIF, the frequency difference is different from the frequency fSIF of the regulated second audio intermediate frequency signal. The lock detection circuit 33 of the first embodiment uses the above characteristics in order to detect the locked/unlocked state, by counting the frequency difference between the oscillation frequency fVOC of the VCO 26 and the sound intermediate frequency fQIF, and then judging whether or not the frequency difference is equivalent to the frequency of the regulated second audio intermediate frequency signal fSIF.

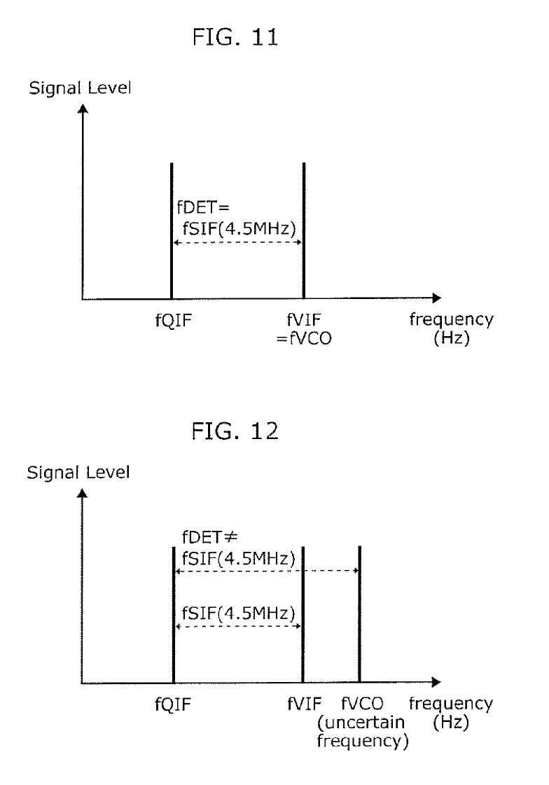

Firstly, processing performed by the receiving apparatus when the PLL circuit 27a is at a locked state. FIG. 11 is a graph showing a relationship, at a locked state, among frequencies of the respective signals in the receiving apparatus. The oscillation frequency fVCO of the VCO 26 is locked at the received video intermediate frequency fVIF, so that the oscillation frequency fVCO becomes equivalent to the video intermediate frequency fVIF. Therefore, the audio mixer circuit 51, which outputs the frequency difference between the oscillation frequency fVCO of the VCO 26 and the sound intermediate frequency fQIF, outputs a signal having a frequency fSIF (=fVIF−fQIF) of the regulated second audio intermediate frequency signal. The output signal of the audio mixer circuit 51 is processed by the BPF 52 having band-pass characteristics of the second audio intermediate frequency signal, so that frequency components of unnecessary video signal and chroma signal are reduced. Then, the resulting signal is amplified by the limiter circuit 53 and then provided to the lock detection circuit 33. The lock detection circuit 33 counts a frequency (fDET) of the input signal 46, thereby judging that this signal is equivalent to the regulated second audio intermediate frequency signal fSIF, in other words, determining that the PLL circuit 27a is at a locked state. Then, an output signal 42 representing the determination result is outputted to the mute circuit 32, the LPF 25a, and the AFT control circuit 30a.

Next, processing performed by the receiving apparatus when the PLL circuit 27a is at an unlocked state. FIG. 12 is a graph showing a relationship, at the unlocked state, among frequencies of respective signals in the receiving apparatus. The oscillation frequency fVCO of the VCO 26 is not locked at the received video intermediate frequency fVIF, so that the oscillation frequency fVCC is an uncertain frequency different from the video intermediate frequency fVIF. Therefore, the audio mixer circuit 51, which outputs the frequency difference between the oscillation frequency fVOC of the VCO 26 and the sound intermediate frequency fQIF, outputs a signal having a frequency that is different from the frequency fSIF (=fVIF−fQIF) of the regulated second audio intermediate frequency signal. The output signal of the audio mixer circuit 51 is processed by the BPF 52 having band-pass characteristics of the second audio intermediate frequency signal, so that the unnecessary frequency components are eliminated. Then, the resulting signal is amplified by the limiter circuit 53 and then provided to the lock detection circuit 33. The lock detection circuit 33 counts a frequency (fDET) of the input signal 46, thereby judging that this signal is not equivalent to the regulated second audio intermediate frequency signal fSIF, in other words, determining that the PLL circuit 27a is at a unlocked state. Then, an output signal 42 representing the determination result is outputted to the mute circuit 32, the LPF 25a, and the AFT control circuit 30a.

The LPF 25a in the PLL circuit 27a changes a response speed of the phase synchronization, based on the output signal 42 of the lock detection circuit 33, More specifically, if it is known from the output signal 42 of the lock detection circuit 33 that the lock detection circuit 33 determines the PLL circuit 27a is at a locked state, then the LPF 25a slows down a response of the PLL circuit 27 by increasing time constant at the state, thereby controlling the PLL operation to make it difficult to respond to phase distortion in noises and the video intermediate frequency signal. On the other hand, if the lock detection circuit 33 determines that the PLL circuit 27a is at an unlocked state, then the LPF 25a speeds up the response by decreasing time constant at the state, thereby expanding a capture range of the PLL.

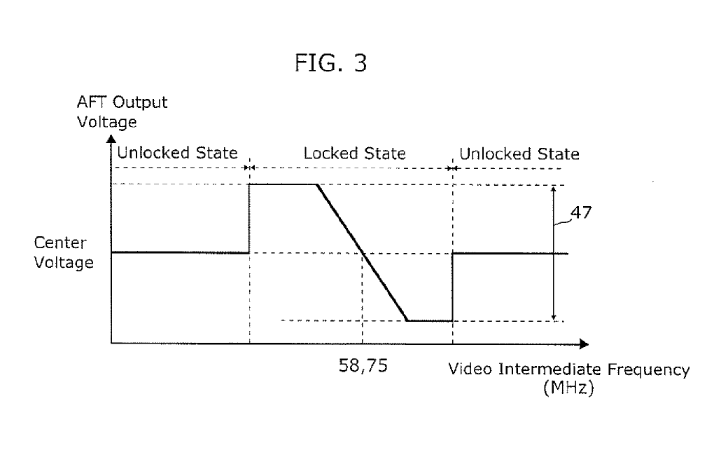

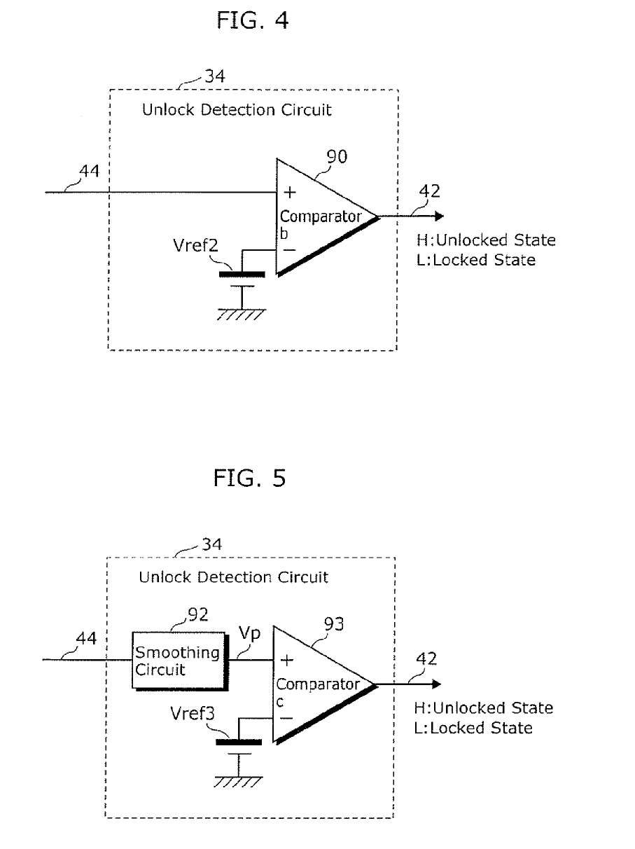

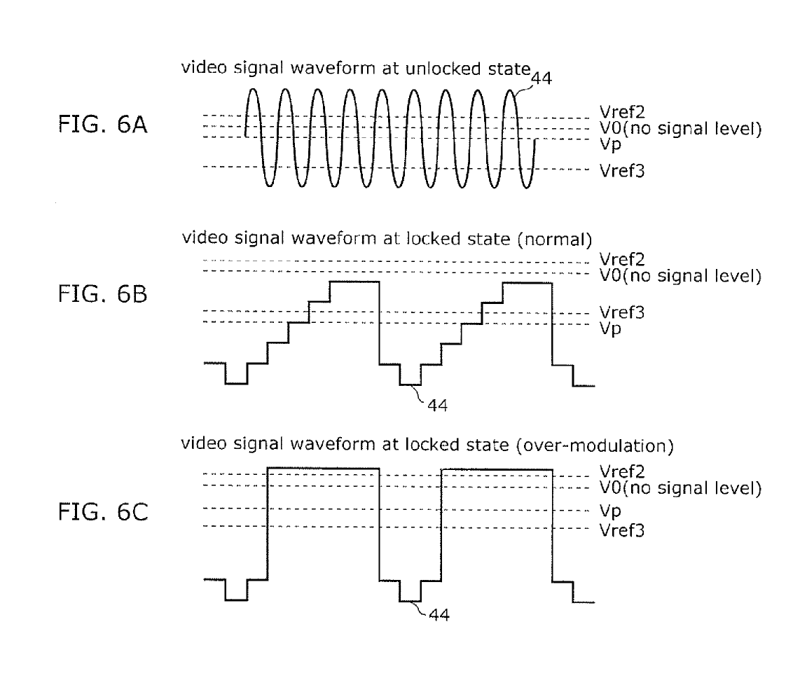

The AFT control circuit 30a controls the channel selection processing performed by the tuner circuit 11, based on the signal s from the VCO 26 of the PLL circuit 27a. More specifically, if the AFT control circuit 30a judges, based on the output signal 42 of the lock detection circuit 33, that the lock detection circuit 33 determines that the PLL circuit 27a is at a locked state, then the AFT control circuit 30a outputs a voltage corresponding to a synchronizing signal from the PLL circuit 27a, in other words, a voltage (voltage varying from a Vcc level to a ground level) corresponding to the frequency difference between the regulated video intermediate frequency and the received video intermediate frequency, as shown in FIG. 3. On the other hand, if the lock detection circuit 33 determines the state of the PLL circuit 27a as an unlocked state, the AFT control circuit 30a outputs a voltage of a constant predetermined value such as a center voltage, as the output signal (AFT output voltage) 40.

The video amplifier 22 selectively amplifies or mutes an output signal (video signal) 44 of the video demodulator 21. The mute circuit 32 is a control circuit which controls the video amplifier 22 to perform selectively amplification or muting, based on the output signal 42 of the lock detection circuit 33. More specifically, if it is known from the output signal 42 of the lock detection circuit 33 that the lock detection circuit 33 determines the PLL circuit 27a is at a locked state, the mute circuit 32 controls the video amplifier 22, so that the output signal (video signal) 44 of the video demodulator 21 is amplified by the video amplifier 22 and outputted from the video signal output terminal 29. On the other hand, if the lock detection circuit 33 determines that the PLL circuit 27a is at an unlocked state, the mute circuit 32 controls the video amplifier 22, so that the output signal (video signal) 44 of the video demodulator 21 is muted by the video amplifier 22 and outputted from the video signal output terminal 29.

The micro-computer 15 receives the output signal 40 having the S-characteristics from the AFT control circuit 30a, and also a synchronizing signal of a video demodulation signal from the synchronizing signal separator circuit 18. In this receiving apparatus, the locked/unlocked state of the PLL circuit 27a is correctly determined by the lock detection circuit 33. Then, depending on the determination result, the mute circuit 32 controls to amplify or mute the output signal (video signal) 44 of the video demodulator 21, thereby eliminating the synchronizing signal, and the micro-computer 15 can correctly judge existence of the synchronizing signal. By these two means, the micro-computer 15 can correctly select receivable channels.

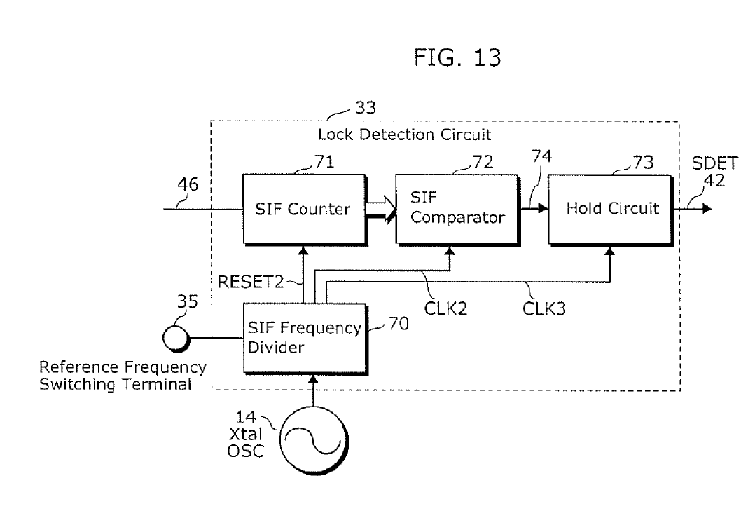

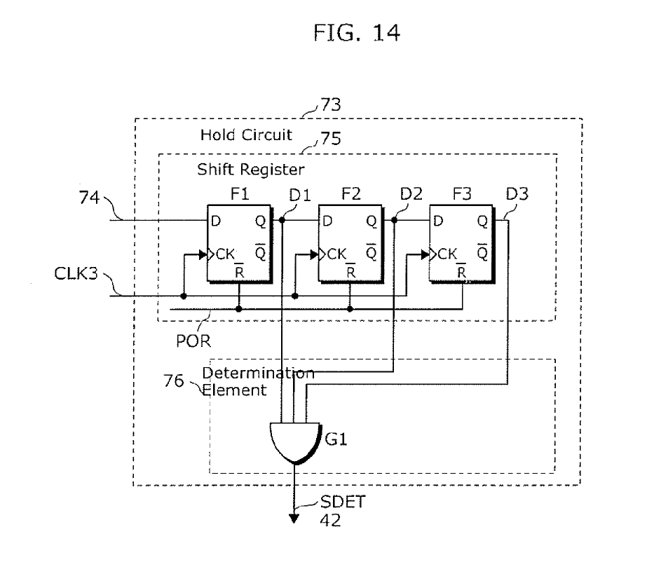

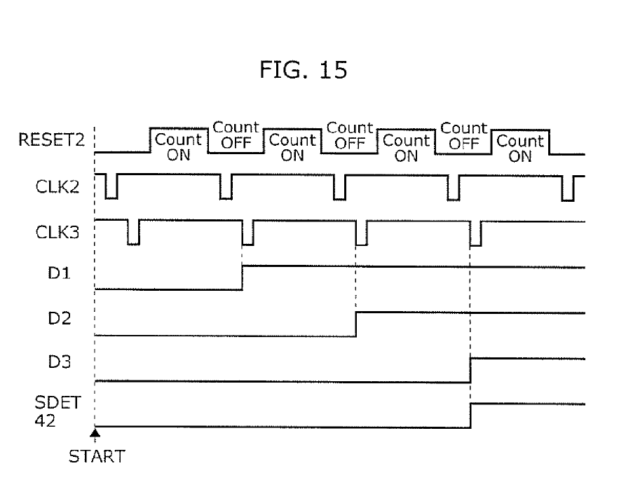

Next, the lock detection circuit 33 is described in detail below. The lock detection circuit 33 has a function of counting signals (fDET) 54 which are outputted from the audio mixer circuit 51 and passed via the BPF 52 and the limiter circuit 53. FIG. 13 is a detailed circuit diagram of the lock detection circuit 33. The lock detection circuit 33 has a SIF frequency divider 70, a SIF counter 71, a SIF comparator 72, and a hold circuit 73. FIG. 14 is a detailed circuit diagram of the hold circuit 73 shown in FIG. 13. In FIG. 14, the output signal (SDET) 42 of the hold circuit 73 is provided to the LPF 25a in the PLL circuit 27a, the AFT control circuit 30a, and the mute circuit 32. FIG. 15 is a time chart showing timings of signals (RESET 2, CLK 2, CLK 3, D1, D2, D3, SDET 42) at the main points in the circuits shown in FIGS. 13 and 14.

Firstly, a reference frequency switching signal corresponding to an oscillation frequency of the XtalOSC 14 is provided from the reference frequency switching terminal 35 to the SIF frequency divider 70. Based on the reference frequency switching signal, the SIF frequency divider 70 performs variable frequency dividing for a reference signal from the XtalOSC 14. More specifically, the SIF frequency divider 70 switches a division ratio to equalize cycles of the output signal RESET 2, and then outputs the signal RESET 2. During a period decided depending on the cycles of the output signal RESET 2 of the SIF frequency divider 70, the SIF counter 71 counts a frequency of a signal (frequency fDET) s which is outputted from the audio mixer circuit 51 and passed via the BRF 52 and the limiter circuit 53.

Depending on the output signal of the SIF counter 71, the SIF comparator 72 judges whether or not a frequency which is outputted from the audio mixer circuit 51 and passed via the BRF 52 and the limiter circuit 53 is equivalent to a frequency 4.5 MHz of the regulated second audio intermediate frequency signal. The second audio intermediate frequency signal is applied with frequency modulation (FM) thereby having a certain band width, so that the band width to be judged is suitably about ±100 kHz. Every time the signal CLK 2 is supplied from the SIF frequency divider 70, the judgment result is provided as an output signal 74 to the hold circuit 73.

While the conventional unlock detection circuit 34 has made the determination of the locked/unlocked state by using an amplitude level of the video signal 44 by analog processing, the lock detection circuit 33 according to the first embodiment makes the determination by counting the oscillation frequency of the VCO 26 by digital processing, as shown in FIG. 13. Thereby, it is possible to restrain, to about 10 kHz, a resolution of a band width, in which the locked/unlocked state is relatively easily determined even if the signal processing is affected by source voltages, an ambient temperature, and also variations of circuit elements such as transistors. As a result, it is possible to stabilize the determination in a simple circuit configuration, without depending the variations. Note that the oscillation frequency of the XtalOSC 14 is set by a set maker or a tuner pack maker, to be 3.58 MHz or 4.00 MHz, for example, as the situation demands. For example, depending on signals from the reference frequency switching terminal 35 corresponding to these reference frequencies, division ratios of the SIF frequency divider 70 are set to 179 and 200, respectively. Thereby, the signal RESET 2 has a frequency of 20 kHz having equal cycles, so that the same SIF counter 71 can deal with different reference frequencies, which thereby simplifies the circuit.

As shown in FIG. 14, the hold circuit 73 includes a shift register 75 and a determination element 76. The shift register 75 has flip-flop circuits F1 to F3. The determination element 76 has a gate G1. Every time the signal CLK 3 is received from the SIF frequency divider 70, the shift register 75 obtains the output signals 74 sequentially by shifting the output signals 74, thereby holding the signals 74 per a predetermined number (three times in the first embodiment). The determination element 76 receives signals D1, D2, and D3 from the flip-flop circuits F1 to F3 in the shift register 75, respectively, per the predetermined number (three times, for example). Then, every time the signals are stored per the predetermined number (three, for example), it is detected whether or not values of all of the signals are the same. Only if the values of all of the signals are the same, then this means the outputs are stabilized, so that the hold circuit 73 determines that the PLL circuit 27a is at a locked state, and outputs a signal (SDET) 42 representing the determination result (locked state) every time the signal CLK 3 is received. With the above configuration, instability in the switching between the locked state and the unlocked state is reduced.

For example, in the instability in the switching between the locked state and the unlocked state, it is assumed that the SIF comparator 72 determines, with a probability m, that the sate of the PLL circuit 27a is a locked state. Here, assuming the predetermined number of shifting is n, a probability that the determination element 76 determines the state as a locked state is mⁿ, and a probability that the determination element 76 determines the state as an unlocked state is 1−mⁿ. Assuming m=0.2 and n=3, a probability that the determination element 76 determines the state as a locked state is mⁿ⁼0.008, and a probability that the determination element 76 determines the state as an unlocked state is 1−mⁿ=0.992. That is, if the hold circuit 73 does not exist, a probability of the determination result of the locked state is 0.2, and a probability of the determination result of the unlocked state is 0.8. On the other hand, if the hold circuit 73 is equipped, the probability of the determination result of the locked state is 0.008, and the probability of the determination result of the unlocked state is 0.992, thereby significantly reducing the instability in the switching between the locked state and the unlocked state.

Next, processing performed by the electric field level detection circuit 31 is described. As described above, the characteristics of the output signal (AFT output voltage) 40 of the AFT control circuit 30a is automatically controlled, so that the characteristics is the stabilized S-characteristics as shown in FIG. 3 when input radio waves are relatively strong, which eventually equalizes the video middle signal frequency outputted from the mixer circuit 61 in the tuner circuit 11. However, when a field level (electric field level) is low, a ratio of noise level to a signal level becomes high, so that the PLL circuit 27a does not lock the phase correctly, which results in instability of the output signal of the VCO 26. Thereby, the AFT control circuit 30a cannot stabilize supply of voltage to the local oscillator 62, which results in instability of a frequency of the local oscillator 62. As a result, the mixer circuit 61 outputs a signal quite different from the regulated video intermediate frequency. Thus, the VIF amplifier 20 eventually receives a signal different from the regulated video intermediate frequency, which worsens the situation where the PLL circuit 27a does not lock the phase. In order to avoid such situation, the electric field level detection circuit 31 judges whether the electric field level of the received video intermediate frequency signal is low or medium/high, thereby controlling to keep the output signal of the AFT control circuit 30a to be a fixed value when the electric field level is low.

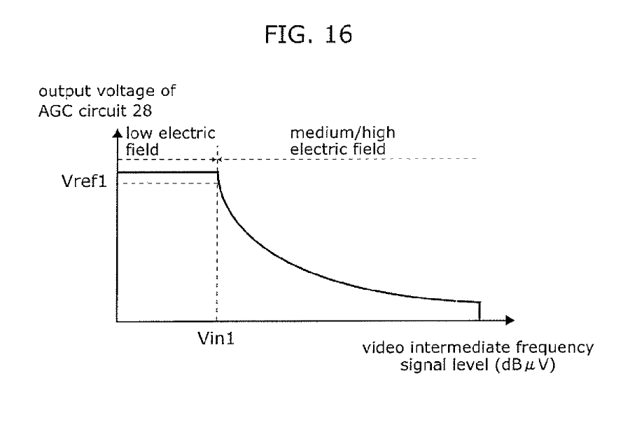

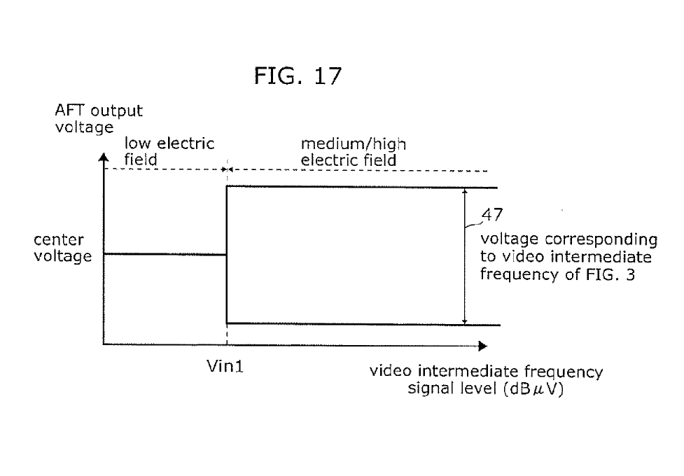

The electric field level detection circuit 31 uses the characteristics of the AGC circuit 28. FIG. 16 is a graph showing the characteristics of the AGC circuit 28. FIG. 16 shows a relationship between (i) a level (dBμV) of the video intermediate frequency signal provided to the AGC circuit 28 and (ii) an output voltage 45 of the AGC circuit 28. The electric field level detection circuit 31 has the comparator a 63 which compares the output signal 45 of the AGC circuit 28 to the reference voltage Vref1, as shown in the detailed circuit diagram of FIG. 8. In a situation where the output signal 45 of the AGC circuit 28 has a low electric field Vin1, in other words, where the output signal 45 is lower than the reference voltage Vref1, this comparator a63 outputs a reversed signal of the output signal 43 representing the situation to the LPF 25a in the PLL circuit 27a, and the AFT control circuit 30a. Thereby, the electric field level detection circuit 31 judges whether the electric field level of the video intermediate frequency signal outputted from the mixer circuit 61 in the tuner circuit 11 is low or medium/high.

If the output signal 43 of the electric field level detection circuit 31 represents that the electric field level is medium/high, so then the LPF 25a in the PLL circuit 27a slows down a response speed of the PLL circuit 27a by increasing time constant, thereby controlling the PLL operation in order to make it difficult to respond to phase distortion in noises and the video intermediate frequency signal. On the other hand, if the lock detection circuit 33 determines that the PLL circuit 27a is at an unlocked state, then the LPF 25a speeds up the response by decreasing time constant, thereby expanding a capture range of the PLL.

The output signal 43 of the electric field level detection circuit 31 is provided to the AFT control circuit 30a and used by the AFT control circuit 30a. FIG. 17 is a graph showing a relationship between (i) level (dBμV) of the video intermediate frequency signal and (ii) an output signal (AFT output voltage) 40 of the AFT control circuit 30a. If the output signal 43 of the electric field level detection circuit 31 represents that the electric field level is medium/high, in other words, higher than Vin1, then the AFT control circuit 30a outputs, as the output signal 40, a voltage (voltage varying from a Vcc level to a ground level) corresponding to a frequency difference between the regulated video intermediate frequency and the received video intermediate frequency, as shown as an AFT output voltage (arrow 47) “during medium/high electric field” of FIG. 17. On the other hand, if the output signal 43 of the electric field level detection circuit 31 represents that the electric field level is low, in other words, lower than Vin1, then the AFT control circuit 30a outputs, as the output signal 40, a regulated certain center voltage, without depending on the input frequency, as shown as an AFT output voltage “during low electric field” of FIG. 17. With the above configuration, it is possible to prevent the instability of the output voltage of the AFT control circuit 30a generated when the inputted intermediate frequency signal has low electric field, which prevents false operation in the channel selecting. As described above, the receiving apparatus using the split carrier method according to the first embodiment has characteristic elements which are: the electric field level detection circuit 31; the lock detection circuit 33; the mute circuit 32 operating based on the detection result of the lock detection circuit 33; the PLL circuit 27a operating based on the detection results of the electric field level detection circuit 31 and the lock detection circuit 33; and the AFT control circuit 30a, so that the locked/unlocked state of the PLL circuit 27a is determined correctly, thereby realizing a correct automatic fine tuning (AFT) system.

### Second Embodiment

Next, the receiving apparatus according to the second embodiment is described.

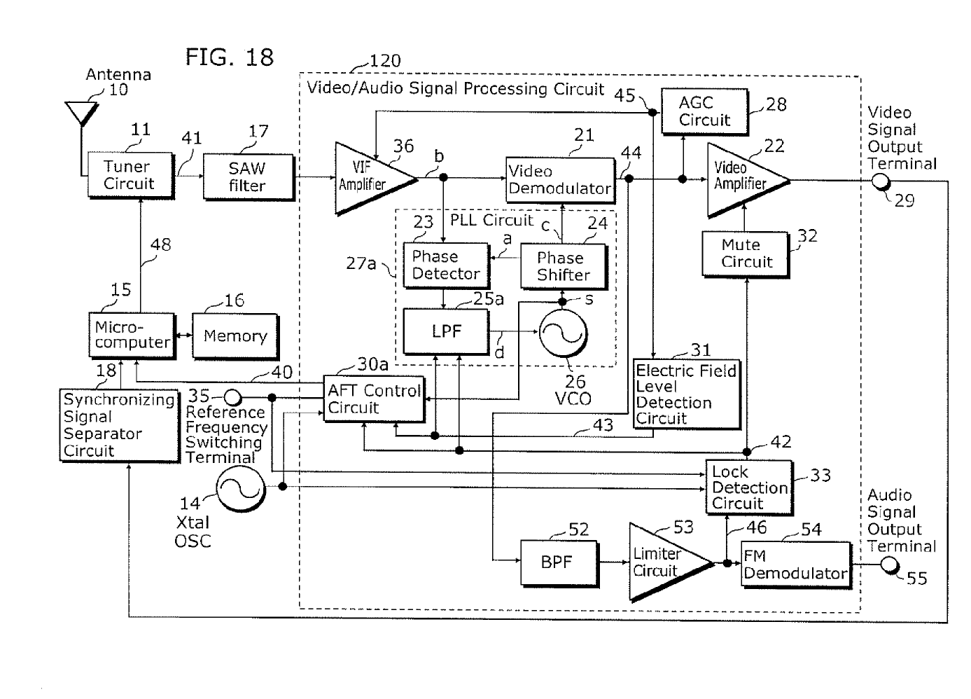

FIG. 18 is a block diagram showing a configuration of the receiving apparatus according to the second embodiment of the present invention. This receiving apparatus receives television signals using an inter carrier method characterized in detection of a locked/unlocked state of a PLL circuit based on the second audio intermediate frequency signal. This receiving apparatus has the antenna 10, the tuner circuit 11, the OSC 14, the micro-computer 15, the memory 16, the synchronizing signal separator circuit 18, a SAW filter 17, and a video/audio signal processing circuit 120.

The video/audio signal processing circuit 120 is a receiving circuit which demodulates, from a signal transmitted from the tune circuit, the first signal and the second signal included in the received signal. In addition to elements having the same functions as the conventional functions (the IF amplifier 36, the video demodulator 21, the video amplifier 22, the AGC circuit 28, the BPF 52, the limiter circuit 53, and the FM demodulator 54), the video/audio signal processing circuit 120 further has elements characterized in the present invention, which are the electric field level detection circuit 31, the lock detection circuit 33, the mute circuit 32, the AFT control circuit 30a, and the PLL circuit 27a. The electric field level detection circuit 31 judges whether the electric field level of a video intermediate frequency signal outputted from the tuner circuit 11 is low or medium/high. The lock detection circuit 33 determines whether the state of the PLL circuit 27a is a locked state or a unlocked state. The mute circuit 32 mutes a video signal 44 at an unlocked state. The AFT control circuit 30a receives, as input, a signal from the electric field level detection circuit 31 as well as signals from the OSC 14, the VCO 26, and the lock detection circuit 33, and outputs an AFT output voltage 40. The PLL circuit 27a has a LPF 25a which operates in response to not only an output signal 42 of the lock detection circuit 33, but also an output signal 43 of the electric field level detection circuit 31.

The receiving apparatus of the second embodiment differs from the receiving apparatus of the first embodiment in that the inter carrier method is used instead of the split carrier method used in the first embodiment. However, the receiving apparatus of the second embodiment is similar to the receiving apparatus of the first embodiment, since each of the both apparatuses has the characteristic elements which are the electric field level detection circuit 31, the lock detection circuit 33, the mute circuit 32, the AFT control circuit 30a, and the PLL circuit 27a.

Note that the video demodulator 21 is one example of the first demodulator, and the BPF 52 is one example of the second demodulator in the claims appended with this specification. In the second embodiment, the same elements are designated by the same reference numerals in the conventional invention and the first embodiment, and structures and functions characterized in the second embodiment are mainly described below.

Processing of video signals performed by the receiving apparatus of the second embodiment is the same as the processing using the split carrier method according to the first embodiment, so that the processing is not described again below. In the following, processing of audio signals performed by the receiving apparatus using the inter carrier method is described.

An audio intermediate frequency signal having a frequency 54.25 MHz is outputted together with a video intermediate frequency signal having a frequency 58.75 MHz from the mixer circuit 61 in the tuner circuit 11. Then, the audio intermediate frequency signal is passed through the SAW filter 17 having band-pass characteristics of both frequencies, and amplified by the intermediate frequency (IF) amplifier 36. The PLL circuit 27a operates to be locked to the amplified video intermediate frequency signal, which enables the video demodulator 21 to perform video demodulation of the video intermediate frequency signal. Furthermore, the video demodulator 21 mixes the amplified audio intermediate frequency signal with a signal of the VCO 26 provided via the phase shifter 24, and eventually outputs the second audio intermediate frequency signal having a frequency 4.5 MHz. This second audio intermediate frequency signal is provided to the BPF 52. The second audio intermediate frequency signal having a frequency 4.5 MHz is passed through the BPF 52 having band-pass characteristics of the second audio intermediate frequency signal. The second audio intermediate frequency signal is amplified by the limiter circuit 53, then applied with FM demodulation by the FM demodulator 54 having an oscillation frequency of 4.5 MHz, and outputted as an audio signal from the audio signal output terminal 55.

Next, the following describes the processing performed by the receiving circuit having the above-described configuration, and a method of determining the locked/unlocked state of the PLL circuit 27a.

Firstly, processing performed by the receiving apparatus when the PLL circuit 27a is at a locked state is described. FIG. 11 is a graph showing a relationship, at the locked state, among frequencies of respective signals in the receiving apparatus. The oscillation frequency fVCO of the VCO 26 is locked at the received video intermediate frequency fVIF, so that the oscillation frequency fVCO becomes equivalent to the video intermediate frequency fVIF. Therefore, the video demodulator 21, which outputs a frequency difference between the oscillation frequency fVCO of the VCO 26 and the sound intermediate frequency fQIF, outputs a signal having a frequency fSIF (=fVIF−fQIF) of the regulated second audio intermediate frequency signal. The output signal of the video demodulator 21 is processed by the BPF 52 having band-pass characteristics of the second audio intermediate frequency signal, so that frequency components of unnecessary video signal and chroma signal are reduced, Then, the resulting signal is amplified by the limiter circuit 53 and then provided to the lock detection circuit 33. The lock detection circuit 33 counts a frequency (fDET) of the input signal 46, thereby determining that this signal is equivalent to the regulated second audio intermediate frequency signal fSIF, in other words, determining that the PLL circuit 27a is at a locked state. Then, an output signal 42 representing the determination result is outputted to the mute circuit 32, the LPF 25a, and the AFT control circuit 30a.

Next, processing performed by the receiving apparatus when the PLL circuit 27a is at an unlocked state is described. FIG. 12 is a graph showing a relationship, at the unlocked state, among frequencies of respective signals in the receiving apparatus. The oscillation frequency fVCO of the VCO 26 is not locked at the received video intermediate frequency fVIF, so that the oscillation frequency fVCO is different from the video intermediate frequency fVIF. Therefore, the video demodulator 21, which outputs the frequency difference between the oscillation frequency fVOC of the VCO 26 and the sound intermediate frequency fQIF, outputs a signal having a frequency that is different from the frequency fSIF (=fVIF−fQIF). The output signal of the video demodulator 21 is processed by the BPF 52 having band-pass characteristics of the second audio intermediate frequency signal, so that the unnecessary frequency components are eliminated. Then, the resulting signal is amplified by the limiter circuit 53 and then provided to the lock detection circuit 33. The lock detection circuit 33 counts a frequency (fDET) of the input signal 46, thereby judging that this signal is not equivalent to the regulated second audio intermediate frequency signal, in other words, determining that the PLL circuit 27a is at a unlocked state. Then, an output signal 42 representing the determination result is outputted to the mute circuit 32, the LPF 25a, and the AFT control circuit 30a.

Note that the lock detection circuit 33, the electric field level detection circuit 31, the mute circuit 32, the LPF 25a, and the AFT control circuit 30a of the second embodiment perform the same processing as described in the first embodiment.

As described above, the receiving apparatus using the inter carrier method according to the second embodiment has characteristic elements which are: the electric field level detection circuit 31; the lock detection circuit 33; the mute circuit 32 operating based on the detection result of the lock detection circuit 33; the PLL circuit 27a operating based on the detection results of the electric field level detection circuit 31 and the lock detection circuit 33; and the AFT control circuit 30a, so that the locked/unlocked state of the PLL circuit 27a is determined correctly, thereby realizing a correct automatic fine tuning (AFT) system.

Note that the receiving apparatus according to the present invention is described by the first and second embodiments, but the present invention is not limited to these embodiments.

For example, in the above embodiment, the locked/unlocked state of the PLL circuit is determined based on an audio signal (second signal) separated from the received signal in which the audio signal (second signal) is overlapped with a video signal (first signal). However, the first signal and the second signal are not limited to the above-described examples, but the locked/unlocked state of the PLL circuit may be determined based on a chroma signal (second signal) separated from the received signal in which the chroma signal (second signal) is overlapped with a luminance signal (first signal). By detecting the locked/unlocked state of the PLL circuit based on the second signal after separating the second signal from the received signal, it is possible to prevent inconvenience during over-modulation (inconvenience that a locked state is wrongly determined as an unlocked state).

### INDUSTRIAL APPLICABILITY

The present invention is able to be used as a receiving circuit or a receiving apparatus for receiving television signals and the like, and especially as a receiving circuit or a receiving apparatus having an AFT control circuit, for example as receiving apparatuses and the like, such as a television receiver, and a video reproduction apparatus having a television tuner.

What is claimed is:

1. A receiving circuit which demodulates a first signal and a second signal included in a signal received from a tuner circuit, said receiving circuit comprising:
a phase lock circuit which generates a synchronizing signal synchronized with a phase of the received signal;
a first demodulator which demodulates a signal including the first signal from the received signal, using the generated synchronizing signal;
a second demodulator which demodulates the second signal from the received signal; and
a phase lock detector which determines whether said phase lock circuit is at a locked state or an unlocked state by judging whether or not a frequency of the demodulated second signal is a predetermined value, and then outputs a lock detection signal representing the determination result to said phase lock circuit,
wherein said phase lock circuit changes a response speed of the phase synchronization based on the lock detection signal.

2. The receiving circuit according to claim 1, further comprising
an electric field level detection circuit which detects electric field level of the received signal and outputs an electric field level detection signal representing the detection result to said phase lock circuit,
wherein said phase lock circuit changes the response speed of the phase synchronization based on the electric field level detection signal.

3. The receiving circuit according to claim 1, further comprising:
a first signal amplifier which selectively performs one of amplification and muting for the demodulated first signal; and
a mute circuit which makes said first signal amplifier selectively perform one of the amplification and the muting, based on the lock detection signal outputted from said phase lock detector.

4. The receiving circuit according to claim 1, further comprising
an automatic fine tuning circuit which controls the tuner circuit to select a channel, based on the synchronizing signal generated by said phase lock circuit,
wherein said automatic fine tuning circuit outputs a voltage corresponding to the synchronizing signal when the lock detection signal represents a locked state as the determination result, and outputs a regulated fixed voltage when the lock detection signal represents an unlocked state as the determination result.

5. The receiving circuit according to claim 1, further comprising:
an automatic fine tuning circuit which controls the tuner circuit to select a channel, based on the synchronizing signal generated by said phase lock circuit; and
an electric field level detection circuit which detects electric field level of the received signal and outputs an electric field level detection signal representing the detection result to said automatic fine tuning circuit,
wherein said automatic fine tuning circuit outputs a voltage corresponding to the synchronizing signal when the electric field level detecting signal represents a medium or high electric field as the detection result, and outputs a regulated fixed voltage when the electric field level detecting signal represents a low electric field as the detection result.

6. The receiving circuit according to claim 1,
wherein said second demodulator includes a mixer circuit which demodulates the second signal from the received signal, by mixing the synchronizing signal generated by said phase lock circuit and the received signal, and
said phase lock detector determines whether said phase lock circuit is at a locked state or an unlocked state, by detecting a frequency of the second signal outputted from said mixer circuit is the predetermined value.

7. The receiving circuit according to claim 1,
wherein said second demodulator includes a band-pass filter which extracts the second signal from the signal including the first signal demodulated by said first demodulator, and
said phase lock detector determines whether said phase lock circuit is at a locked state or an unlocked state, by detecting a frequency of the second signal outputted from said band-pass filter is the predetermined value.

8. The receiving circuit according to claim 1,
wherein said phase lock detector includes:
a frequency divider which performs variable frequency dividing for a reference frequency provided from a reference signal source, depending on a reference frequency switching signal;
a counter which counts a frequency of the second signal, during a period decided by a cycle represented by a signal outputted from said frequency divider; and
a comparator which judges whether or not the frequency counted by said counter is a predetermined value.

9. The receiving circuit according to claim 8,
wherein said phase lock detector further includes
a hold circuit which holds a series of the judgment results of said comparator per a predetermined number of the results, and outputs the lock detection signal which represents whether or not the determination results held per the predetermined number are the same results.

10. The receiving circuit according to claim 1,
wherein the first signal is a video signal, and
the second signal is an audio signal corresponding to the video signal.

11. The receiving circuit according to claim 1,
wherein the first signal is a luminance signal, and
the second signal is a chrominance signal corresponding to the luminance signal.

12. A receiving apparatus which demodulates a first signal and a second signal included in a signal received by an antenna, said receiving apparatus comprising:
a tuner circuit which retrieves a signal of a selected channel from the received signal; and
the receiving circuit according to claim 1 which demodulates the first signal and the second signal included in the signal retrieved by said tuner circuit.

13. A receiving method of demodulating a first signal and a second signal included in a signal received from a tuner circuit, said receiving method comprising:
demodulating a signal including the first signal from the received signal, using a synchronizing signal obtained from a phase lock circuit;
demodulating the second signal from the received signal; and
determining whether the phase lock circuit is at a locked state or an unlocked state by judging whether or not a frequency of the demodulated second signal is a predetermined value,
changing a response speed of the phase synchronization of the phase lock circuit, based on the determination result.
